(19) United States
(12) Patent Application Publication
(10) Pub. No.: US 2015/0027353 A1
(43) Pub. Date: Jan. 29, 2015

(54) ACTIVE SAFE

(71) Applicant: TenCate Advanced Armor USA, Inc., Newark, OH (US)

(72) Inventor: Erick James Sagebiel, Castroville, TX (US)

(21) Appl. No.: 14/444,449

(22) Filed: Jul. 28, 2014

Related U.S. Application Data
(60) Provisional application No. 61/858,724, filed on Jul. 26, 2013.

(51) Int. Cl. E05G 1/10; E05G 1/14

(52) U.S. Cl. CPC E05G 1/10; E05G 1/14
USPC 109/24; 109/23; 109/36; 109/38

(57) ABSTRACT

Active containers and related systems configured for destroying container contents may include safes with a hardened storage space, a content destruction element configured to destroy material contained in the storage space, and an arming device. The content destruction element may include, for example, an incendiary, an explosive, a liquid, a gas, a magnet and/or an electrical source. The arming device may be configured to arm and initiate the content destruction element using various modes, which may be based on different arming criteria and firing criteria. The arming criteria and/or the firing criteria may include movement of the container, acceleration, penetration of the container, elapsed time, an arming signal, as well as an explicit firing signal. The container may include various sensors to assist in making relevant determinations, such as a positioning system, an accelerometer, a heat sensor, a pressure sensor, etc.

### CROSS REFERENCE TO RELATED APPLICATIONS

This application claims priority under 35 USC 119(e) to U.S. Provisional Patent Application No. 61/858,724, filed Jul. 26, 2013, titled “Active Safe,” the content of which is hereby incorporated by reference in its entirety.

The present invention generally relates to systems and methods for actively protecting material, such as sensitive or classified documents, computing devices, electronic storage devices and/or media and cryptographic material, that are contained in a safe or other container.

### BACKGROUND OF THE INVENTION

Options for securing data on the front lines is limited to a variety of passive safes aided by guards and alarms. Currently, most safes provide a layer of passive defense to ward off intrusion until the perpetrators can be neutralized or they give up. However, with some materials and information, it is not acceptable to simply assume that the safe (or the area where the safe is kept) can be re-secured in time before the safe is compromised or stolen (e.g. front line DOD and DOS safes, critical data, etc.). For these scenarios, additional assurances that the material has been kept uncompromised is paramount along with allowing key personnel to escape (without either prematurely destroying data, losing precious time trying to destroy data, or being captured with said data).

The Class 5 GSA approved safe, a common safe for these endeavors, contains only passive protection and is built to withstand a direct attack for a limited time (in accordance with Fed spec AA C 2786 which requires the safe to provide 20 man hours against surreptitious entry, 30 minutes against covert entry, and 10 man minutes against forced entry). These Class 5 safes can be approved to not only store hard data, but also as specialty IPS containers approved to allow for classified computing. GSA Class 6 safes, another commonly utilized storage enclosure, are certified to provide even less protection. Additionally, though the majority of these safes are not easily portable, it is possible that, once the physical security protecting the safe's location is compromised, they could be moved to different locations to more readily open and disseminate the data.

While current levels of protection may be deemed “adequate” for normal operations, this is based on the premise that reinforcements will be able to re-secure the safe and its contents within a limited amount of time. In many frontline scenarios, these reinforcements are not guaranteed to arrive in any specified amount of time, as seen in several recent events. This leaves the frontline personnel with the options of: immediately destroying the sensitive material (potentially prematurely losing irreplaceable data and placing themselves at risk while performing such a task), abandoning the material (which is not advised if it is truly critical and/or endangering information), or trying to take the material with them (placing the person and material in a potentially dangerous scenario, where the data is subject to compromise until re-secured in an appropriate location). Methods of quickly and effectively destroying the data range from giant shredders, trash can fires, to incendiary grenades. None of which are ideal for quickly and quietly escaping.

Additionally, many military units travel with cryptographic or other sensitive material that can compromise operational security if captured by the enemy. Although some cryptographic devices have features that automatically erase their memories, such features usually require human activation, which may be impossible, e.g. due to user incapacitation, or impractical in a combat situations. Additionally, although electronic memory wipes may be effective in destroying some sensitive information, these are not universally available on all electronic storage and/or computing devices, and there are other types of materials that cannot so easily be destroyed, e.g. optical discs or hard copies.

### BRIEF SUMMARY OF THE INVENTION

According to certain aspects of the invention, active containers and related systems configured for destroying container contents are disclosed. In some examples, a means of destroying the material and/or information housed in a safe or other container may be provided that can be activated, for example, if the safe or other container is in the process of being compromised. In some examples, this may be accomplish using methods and materials that allow the active container to be considered relatively low-hazard (or safe) during normal operation, and robust during compromise. This may involve, for example, adding an active destruct mechanism to a Class 5, Class 6, or other safe, and/or other containers, that is configured to facilitate the reliable destruction of the safe/container contents. In some examples, this may also be accomplished with minimal risk of collateral damage beyond the boundaries of the container, and/or may limit the potential of collateral damage by venting or directing potentially harmful heat, pressure or other energy, in a predetermined direction.

As used herein, “destroying material” should be understood as a transformation of the relevant material to a state whereby information included in, or on, such material is no longer practically useable or discernible. This does not necessarily rule out any possible reconstruction of the information by advanced forensics, but will, at a minimum, make the information unrecoverable using the standard techniques typically used to read such information. Physical destruction may include transformations such as burning, vaporizing, dissolving, and/or melting, whereas information destruction may include transformation of electronic storage to a different calculated, random, predefined, and/or uniform state, or other erasure or obfuscation of written, visible or readable data.

In some examples, the active container may be configured to passively protect the contents (e.g. a safe or other secure container), and to destroy the contents and/or data included on the contents if the container is in danger of, or in the process of, being compromised.

According to further aspects of the invention, an active container may include one or more of a storage space, a content destruction element configured to destroy material contained in the storage space, and/or an arming device configured to arm the content destruction element based on an arming criteria, and/or to initiate the content destruction element based on a firing criteria.

In embodiments, the content destruction element may include, for example, an incendiary, an explosive, a liquid, a gas, a magnet and/or an electrical source.

In embodiments, the arming criteria and/or the firing criteria may include two or more of movement of the container, acceleration, penetration of the container, elapsed time, an arming signal, and a firing signal.

In embodiments, the container may include a positioning system (such as a GPS, or other locator) configured to determine a position and/or movement of the container, and/or an accelerometer configured to detect an acceleration of the container.

In embodiments, the arming device may be further configured to disarm the content destruction element based on a disarm signal and/or a container opening. As used herein, a “container opening” should be understood as the opening of a preconfigured door or other access point that has one or more criteria that help distinguish authorized openings from breaches of the container. Some opening criteria may include, for example, disarming and/or disengaging a locking mechanism, predetermined simultaneous movement of components (e.g. rotation of door and hinge), etc.

In embodiments, the container may include an enclosure configured to mitigate an effect of the content destruction element outside of the container, and/or to direct an effect of the content destruction element in a particular direction. Mitigating an effect of the content destruction element outside of the container may include, for example, containing destructive energy (such as heat and/or blast) within the container, absorbing a portion of destructive energy within the container, containing destructive chemicals (such as a reactive liquid or gas) within the container, or absorbing and/or containing a portion of destructive chemicals within the container. Directing an effect of the content destruction element in a particular direction may include, for example, directing destructive energy (such as heat and/or blast) through a relatively weak area of the container, directing destructive energy via directional and/or shaped charges and the like, directing destructive energy through a vent of the container, directing destructive chemicals (such as a reactive liquid or gas) through a vent or drain of the container, or focusing magnetic and/or electrical energy in a specific direction, e.g. to increase the relative effectiveness of the magnetic and/or electrical energy within the storage space.

In embodiments, the container may include a communication link configured to allow communication with an electronic device in the storage space, and/or a power link configured to provide power to the electronic device in the storage space.

In embodiments, the arming device may be configured to arm the content destruction element based at least in part on a signal received from outside of the container.

In embodiments, the container may contain an alarm (e.g. a siren, a light, etc.) configured to activate based at least in part on the content destruction element being armed.

In embodiments, the container may be a GSA class 5 safe, a GSA class 6 safe, or other classification of safe.

According to further aspects of the invention, a system may include one or more of a container, a content destruction element configured to destroy material in the container, and/or an arming device configured to arm the content destruction element based on an arming criteria, and to initiate the content destruction element based on a firing criteria.

In embodiments, the arming criteria may include movement of the container, acceleration, penetration of the container, and/or an arming signal, and the firing criteria may include movement of the container, acceleration, penetration of the container, elapsed time, and/or a firing signal.

In embodiments, the container may be included in a vehicle. In embodiments, the arming criteria may include an arming signal provided by an active countermeasure system onboard the vehicle, and/or the firing criteria may include a firing signal provided by the active countermeasure system onboard the vehicle.

In embodiments, the system may include a first sensor, a second sensor, and a processor in communication with the first sensor, the second sensor and the arming device. In some examples, the processor may be configured to arm and/or initiate the content destruction element based on results of processing signals from the first sensor, and/or based on results of processing signals from the second sensor.

In embodiments, the system may include an alarm configured to activate based on the content destruction element being armed, and/or a controller in communication with the arming device. In some examples, the arming device may be configured to disarm the content destruction element based at least in part on input received from the controller. In embodiments, the controller may be, for example, a control panel on an outside of the container, a control panel on a vehicle, or a remote control.

According to further aspects of the invention, method of destroying material in a container may include one or more steps of arming a content destruction element based on an arming criteria, activating an alarm based on arming the content destruction element, monitoring, by at least one microprocessor, a firing criteria, and initiating the content destruction element based on the occurrence of the firing criteria, and/or making the content destruction element safe based on a disarm signal.

In embodiments, occurrence of the arming criteria and/or the firing criteria may be determined based on data provided by a sensor of the container.

In embodiments, the material may include data stored on an electronic device, and the content destruction element may include an incendiary, an explosive, a magnet and/or an electrical source.

In embodiments, the material may include printed text or images, and the content destruction element may include an incendiary, a liquid and/or a gas.

According to aspects of the foregoing embodiments, systems that are safe during normal operation, but that reliably destroy the contents prior to the safe/container being compromised, may be provided. This may be accomplished, for example, by having a small destructive energetic device located inside the safe initiate when an armed series of sensors detect a compromised state through a defined series of gates. In such a system, all of the components (including those described above and below) may be ruggedized, waterproofed, etc., e.g. to enhance the robustness and reliability of the active container in harsh environments including field and/or FOB conditions, buildings and/or vehicles under kinetic attack, etc.

According to further aspects of the invention, in situations of potential position compromise (such as embassies or FOBs), classified material may be effectively and reliably prevented from falling in enemy hands, without requiring a person to prematurely destroy material, or further endanger their lives (or the material) trying to escape with sensitive material in hand. In some examples, the user can quickly arm the active container (e.g. for a preset time, with tamper sensitivity or other firing criteria), and relocate to a defensive position or other position of safety. If the time expires or the safe is tampered with, the material inside the safe is destroyed by a destructive element, such as a thermite or explosive charge, a reactive chemical, and/or electromagnetic energy.

In some examples, systems may include features such as:

1) A safe having a locking mechanism;

2) Thermite or other destructive material configured to destroy contents of the safe;

3) The safe may include or use an array of sensors including:
a. Accelerometers, gyros, location systems, etc.;
b. Break screens, or other sensors in the body of the safe, for sensing penetration;

4) Safe can be plugged in to power and/or utilize an onboard battery;

5) Data and power ports to allow computer to be utilized while safely locked up;

6) External arm device for quick arming;

7) Multiple tamper, movement, event, and/or time settings; and/or

8) Disarm on door open, unlock, and/or external keypad or other controller.

As used herein, a content destruction element may include various explosive, incendiary, liquid, electronic, magnetic, or other means by which container contents, such as documents, computing devices, storage media, and/or cryptographic material, may be reliably destroyed or rendered unusable. In some examples, the content destruction element may be tailored to a specific type of content and/or may be replaceable to include different types and/or amounts of destructive material. For example, a content destruction element may be configured to destroy documents using an incendiary that has a relatively-low burn temperature, whereas a content destruction element that is intended to destroy computing devices may include high-temperature incendiaries and/or explosives that can reliably destroy storage media through computer cases, etc. Certain reactive chemicals (e.g. including liquids and gasses) may also be used, for example, to dissolve media, obfuscate and/or destroy printed text or images, etc.

In some examples, the content destruction element may include a plurality of different destruction means, such as explosive, incendiary, chemical and/or electronic means. In some examples, a user may select the type of destruction means to be used beforehand and/or during an arming/destruct sequence. In some examples, systems may be configured to automatically select a destruction means based on, for example, a detected event, a detected content, a predefined setting, etc.

In some examples, the content destruction element may be configured to destroy contents of the container without destroying the container, and/or to project the blast or other harmful energy in a certain direction (such as toward the base of the container or through a venting element).

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the related technology. No attempt is made to show structural details of technology in more detail than may be necessary for a fundamental understanding of the invention and various ways in which it may be practiced. In the drawings:

FIG. 1 depicts an exemplary active container according to aspects of the invention.

FIG. 2 depicts another view of the exemplary container shown in FIG. 1.

FIG. 3 depicts another exemplary active container included in a vehicle according to aspects of the invention.

FIG. 4 depicts another exemplary active container in communication with different devices according to aspects of the invention.

FIG. 5 is a schematic block diagram of aspects of an exemplary TAS consistent with the present invention.

### DETAILED DESCRIPTION OF THE INVENTION

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise. Thus, for example, a reference to “a sensor” is a reference to one or more sensors and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law.

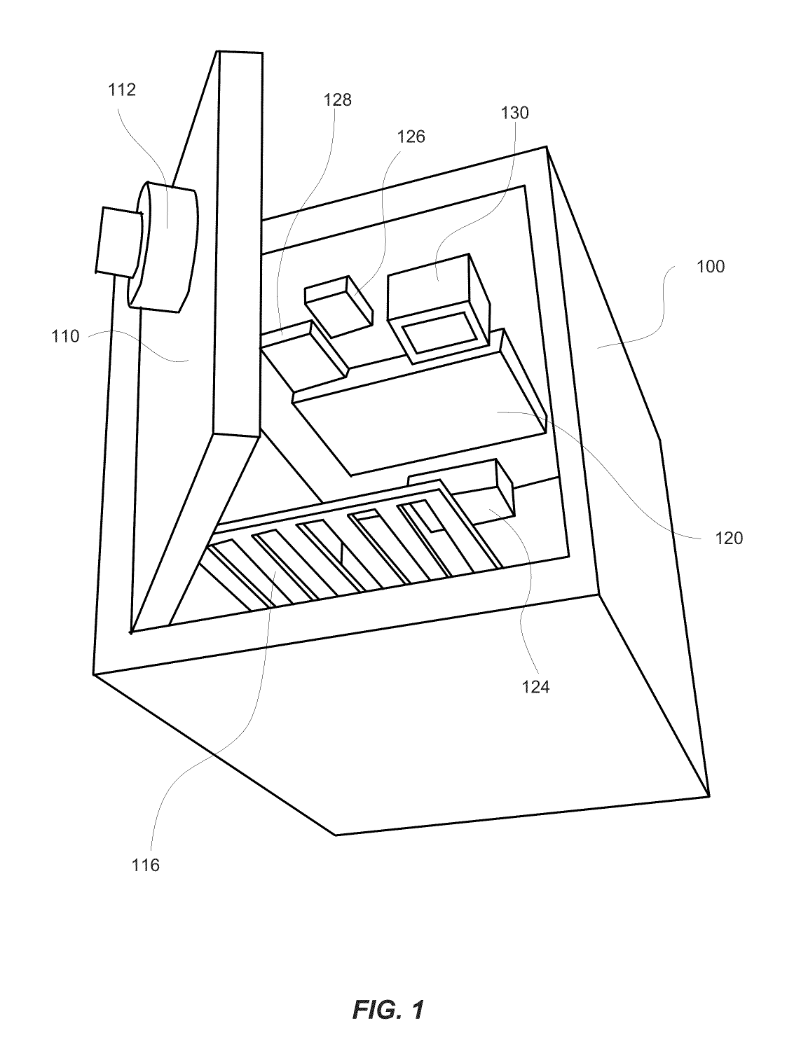

As shown in FIG. 1, an active container 100 may include a door 110, a locking mechanism 112, a rack or shelf 116, a processor 120, a battery 124, an internal safe and arming switch 126, an internal sensor package 128, and a content destructive element 130.

Active container 100 may be based on, for example, a safe built off existing GSA Class 5 or other standards, and include additional features designed to offer improved protection as discussed herein. In some examples, container 100 and/or battery 124 may have an external power lead (that powers any elements of container 100 and/or allows charging of the battery 124) and/or an internal power plug that allows other electronic devices (not shown) to be powered by an external power supply and/or battery 124. In some examples, battery 124 may be configured as a failsafe to provide power to processor 120, safe and arming switch 126, sensor package 128, destructive element 130 and/or other devices in container 130 in the event that an external power source is interrupted.

Active container 100 may include an onboard processor 120 configured to monitor, for example, the sensors included in sensor package 128 and/or switches or other input received via any number of communication elements (e.g. transceivers, network cables, etc.) to determine if arming and/or firing criteria have been satisfied and whether to send arming, alarm, and/or firing signals to the content destructive element 130 or other elements. The processor 120 may also be configured to include features similar to those of active countermeasure systems such as described in PCT/US2013/057503, filed Aug. 30, 2013, and titled “ACTIVE BLAST COUNTERMEASURES,” the contents of which are hereby incorporated by reference in their entirety. For example, the processor 120 may be configured to arm itself (and/or arm the destructive element 130) if the processor receives an explicit arm signal from an external source (such as a control panel or remote control), and/or if the container 100 experiences a triggering event such as increased heat (e.g. greater than 300 deg F. and/or greater than 100 deg F. per second change), pressure changes (e.g. multiple, or greater than 10.0, atmospheres in less than 1.0 sec), rapid acceleration (e.g. greater than 20 g, greater than 40 g, in a range of about 40 g to 60 g, or about 50 g), etc. In some examples, the processor 120 may include a buffer of sensor data from sensor package 128 (or other external sensors discussed herein) that temporarily stores sensor data obtained at intervals less than 1.0 second, less than 0.1 second, or less than 0.01 second. For example, the buffer may be segmented in windows in a range of 1-10 ms, and may be configured to arm the destructive element 130 and/or activate a local or remote alarm within about 10-20 ms of an initial sensor reading, such as acceleration, heat and/or pressure, exceeding a first threshold.

Likewise, the processor 120 may be configured to initiate the destructive element 130 if it receives an explicit fire signal from an external source (such as a control panel or remote control), or if the container 100 continues to experience a (or experiences a new) triggering event such as increased heat, pressure, rapid acceleration, etc. In some examples, the processor 120 will only initiate firing if it is already in an “armed” state, and/or if an appropriate alarm has been positively activated.

In some examples, the processor 120 may be further configured to receive a “ready” command that allows the container 100 to be armed. For example, a user may want to make the container 100 more fully “safe” (e.g. disabling one or more active features) when no sensitive material is being stored in the container 100 and/or when the container 100 is open. Accordingly, the user can toggle between “ready” and “not ready” states, e.g. using a control panel of the container), or the container can be configured to automatically enter a “not ready” state, e.g. when the door 110 is open. In some examples, such signals may be sent to the container 100 remotely and may be used, for example, if an aircraft, ship, submarine or other vehicle is compromised, but the command authority does not want to destroy sensitive information. Thus, the container 100 can be remotely disabled so as not to arm and/or activate destructive element 130. In some examples, certain triggering events may be based on detection of liquid within the container 100, e.g. if water is detected in the container, a thermite or explosive charge may be effectively used to destroy material in the container 100, even if submerged and/or the seals of the container are compromised.

In some examples, processor 120 may be configured to communicate with a plurality of similar or dissimilar destructive elements. The plurality of destructive elements may be configured to arm and/or initiate separately from one another, initiate sequentially with one another, and/or initiate together, as well as selective combinations thereof. For example, under the control of a processor 120, certain firing events may involve firing a certain destructive element (e.g. of a certain kind such as an incendiary), whereas other firing events, such as in different operational modes set by a user, may involve firing a different destructive element (e.g. of another kind such as a high explosive). Such flexibility can provide numerous advantages such as allowing the user to tailor the destructive element to the nature of the material in the container (e.g. if storing dissolvable paper with or without reactive inks, versus computers with magnetic storage), the sensitivity of the material and required level of physical destruction, and/or operational environment and acceptable level of collateral damage.

In some examples, the container 100 may be configured to support operation of various electronic devices within the container. For example, the processor 120 may include a wired and/or wireless communications link that is useable by an electronic device placed on shelf 116, and container 100 (or battery 12) may include a power outlet that the electronic device(s) can plug in to.

As shown in FIG. 1, the processor 120 (along with other elements such as battery 124, safe and arming switch 126 and sensor package 128) may be protected by being located in the container 100, and shielded from damage or destruction related to fire, kinetic attack, etc. In some examples, all of the elements included inside of container 100 may be powered (if at all) by an internal power source, such as battery 124, and wirelessly communicate (if at all) with elements outside of the container 100, whereby the container 100 may include no wires that penetrate the container housing.

The processor 120 may also be configured to provide and/or support intrusion prevention system (IPS) functions (e.g. intrusion detection) based on sensor data received from any of safe and arming switch 126, sensor package 128 or other sensors (e.g. hinge rotation, door movement, locking/unlocking sensors, etc.). The processor 120 may be further configured to disarm itself and/or the destruction element 130 based on a disarm signal and/or a container opening.

Active container 100 may be fitted with one or more sensor packages 128 including, for example, an accelerometer, a triaxial accelerometer, a positioning system receiver, heat sensor, pressure sensor, liquid sensor, motion sensor, audible sensor, penetration and/or break sensor, etc. In some examples, different sensors may be “listened” to by the processor 120 in order to determine arming and/or firing events. For example, if the container is locked, the processor 102 may register any opening of door 110 as an arming and/or firing event. Alternatively, the user can set an “away” state (e.g. meaning that the container is unsupervised) in which any movement of the container may register as an arming and/or firing event. Multiple variations are possible and may depending on the specific environment that the container is being used in. For example, motion sensors may be disregarded in containers on vehicles during vehicle operation, and reactivated if the vehicle is shut down or otherwise immobile. Thus, in certain examples, processor 120 may be programmable (e.g. via a remote control or control panel) to specify arming and/or firing criteria, sensor settings, etc. In some examples, the container 100 may be configured to automatically transition between operational states (with different event criteria and/or sensor activation) based on triggering events, such as, for example, a remote state-change signal, vehicle operation, and/or vehicle or building alarms (such as general quarters, fire alarms, etc.).

In some examples, a penetration sensor may be fitted within layers of safe material, such as within the walls and/or door of container 100, and may register any wall penetration.

In some examples, accelerometers or other sensors may be fitted within the housing of processor 120, e.g. depending upon the sensor size, mounting, etc., and may be mounted to a circuit board with the processor.

In some examples, the destructive element 130 may be configured to destroy various material placed on shelf 116, or otherwise stored in the container 100. In some examples, destructive element 130 may include one or more of an incendiary, an explosive, a liquid, a gas, a magnet and/or an electrical source.

In some examples, the destructive element 130 may be configured to physically destroy material such as by burning, vaporizing, dissolving, and/or melting the material. In some examples, the destructive element 130 may be configured to destroy information e.g. via transformation of electronic storage to a different calculated, random, predefined, and/or uniform state, or other erasure or obfuscation of written, visible or readable data (e.g. using reactive chemicals).

In some examples, an incendiary device such as thermite may be utilized to destroy the contents of the container 100. As shown in FIG. 1, this energetic (or others) may be kept in a sealed and shielded housing of element 130 located near the processor 120 at the top of the safe. In some examples, small incendiaries, or other elements, may be placed at various locations in the container, e.g. to focus the energy directed inward and/or distribute the energy directed outward. The destructive element 130 may include shaped or otherwise directed charges to enhance the destructive effect, and may include combinations of materials that are used in conjunction to enhance the destructive capability of the element 130 (e.g. multiple reactive chemicals, accelerants, etc.). It is noted that a thermite, or other, reaction may be sized or otherwise configured to assuredly destroy material such as plastic and thin metals within the container 100 without creating a hazard outside the container (and/or such that any hazard would be localized to a safe direction or delayed until after friendly personnel have cleared the area).

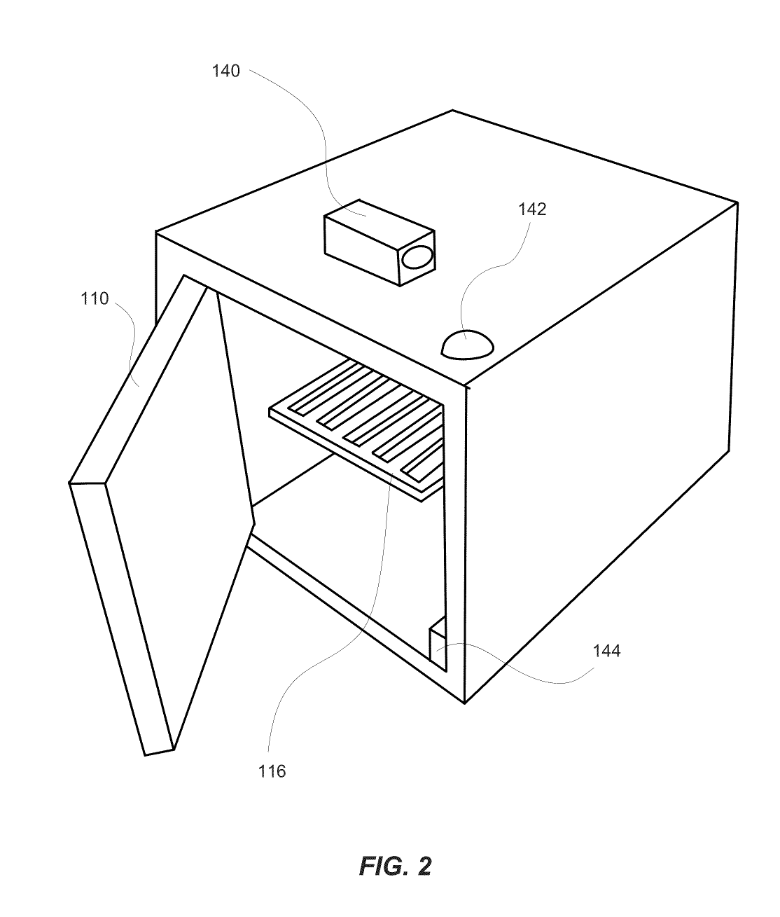

As shown in FIG. 2, the container 100 may be be fitted with a series of switches, or other controls, on controller/panel 140 located on the exterior, which may allow the container to be easily “armed” into different modes. The controller/panel 140 may be configured to inhibit accidental arming of the container, e.g. by protective cover, passcodes, cryptographic keys, etc. In some examples, controller/panel 140 may include a transceiver and/or network cable adapter to connect with a remote controller that can perform any of the functions described herein, such as activating an alarm on the container, arming and initiating the destructive element, etc. Different operational modes may allow a user to alter the level of “alert” for the container 100. In some examples, the container 100 may be made ready and/or armed from outside of the container 100 (e.g. via controller/panel 140), and made safe using safe and arming switch 126 located on the inside of the container 100 once opened by the user.

In some examples, controller/panel 140 may also include various sensors, such as those described in conjunction with sensor package 128. Including sensors on the outside of the container 100 may be beneficial, for example, in detecting submersion, fire, blast or other hazardous conditions outside of the container (before they register on the internal sensors). In some examples, the sensor data and/or control signals generated in controller/panel 140 may be communicated wirelessly to the processor 120 inside of the container 100 (e.g. to limit the wiring that penetrates the container housing), or there may be a wired connection between the controller/panel 140 and the processor 120. In some examples, the container 100 may be configured to communicate with similar containers, e.g. via a wired or wireless connection with controller/panel 140, and may send and/or receive arming and/or initiating signals to or from the other containers. This may be beneficial, for example, if a building or facility is being overrun, allowing all containers to arm and/or initiate together without the need for every container to be manually armed.

Container 100 may include an exterior alarm 142 such as a light, a display, a speaker and/or a siren. In some examples, the container 100 may be configured to activate the alarm 142 based on the destructive element 130 being armed. For example, when the processor 120 arms the destructive element 130, a visible and/or audible alarm may be activated to alert personnel that a material destruct state and/or sequence has been initiated. This may include display and/or announcing a time remaining until the destructive element is initiated, or changing a light color (e.g. green for “not ready,” yellow for “ready,” and red for “armed.”

In some examples, a door sensor 144, or other internal sensor may be used to help distinguish proper container openings from unauthorized breaches, e.g. by disregarding movement within the container 100 if sensor 144 (and/or hinge or other sensors) registers a proper opening of door 110.

In some examples, a container such as those described above could be integrated with a vehicle structure, or attached as part of an additional kit, e.g. to provide a cryptographic and/or sensitive material destruction device. Such systems may be configured to communicate with active countermeasure or other systems that detect violent disruptions, such as IED, rocket or other attacks on the vehicle, and may be further configured to arm the container and initiate the content destruction element.

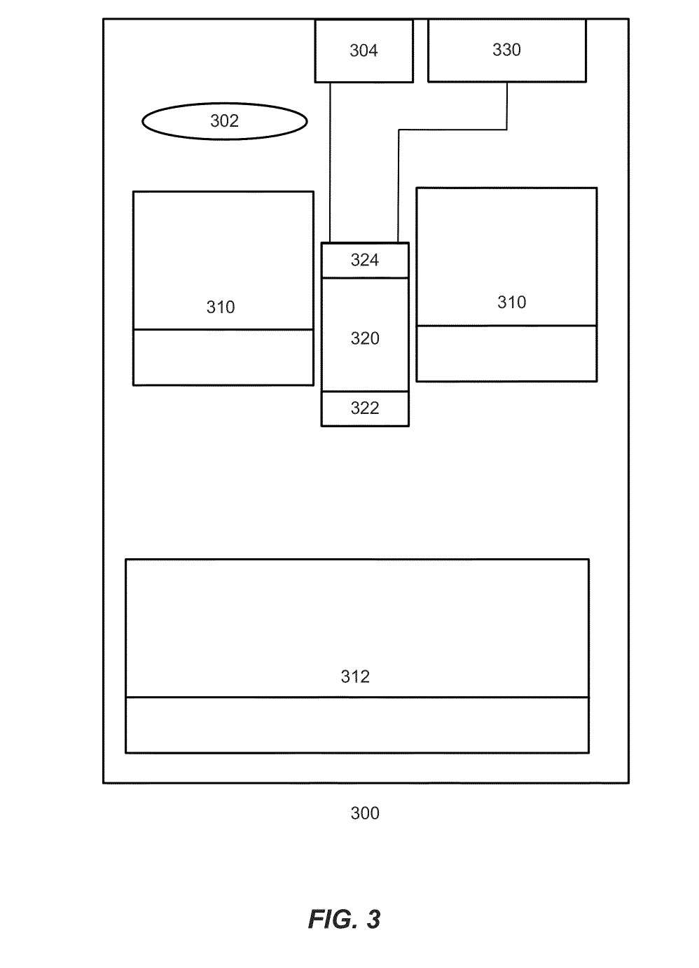

FIG. 3 shows an active container 320, which may include features similar to those described with respect to container 100, mounted in a vehicle 300. The vehicle 300 is depicted as a car or truck with a steering wheel 302, front seats 310, and back seat 312, but could be virtually any type of vehicle such as an aircraft, a boat, a ship, a submarine, a tracked vehicle, etc. Vehicle 300 includes a power source 304 that provides power to container 320, and a trigger and activation system (TAS) that can send and receive sensor data and/or commands to and from the container 320. The container 320 may include a power and/or communication interface 324 for communicating power and/or data with power source 304 and/or TAS 330. Interface 324 may include, for example, power couplings, wired data links, wireless data links, etc.

Container 320 may also include a communication interface 322 that is configured to provide communication links to devices (such as radios and/or cryptographic devices) contained in container 320. Interface 322 may include, for example, an internal wireless transceiver, an external wireless transceiver, an internal wired connection, and/or external wired connection.

In some examples, the container 320 may be configured to make itself ready, arm a destructive element, and/or initiate the destructive element based on signals received from the TAS 330. In some examples, the TAS 330 may arm the container 320, and the container 320 may then independently determine whether to initiate the destructive element. For example, the TAS 330 may experience a catastrophic event that can arm the container 320 within 10 ms of detecting a blast. Once armed, the container 320 can be disconnected from the TAS 330, e.g. if the vehicle is destroyed, but still maintain operation of the internal components (which may be protected, at least temporarily, in the hardened case). A processor, such as processor 120, included in the case 120 may make an independent decision to initiate the destructive device, e.g. based on elapsed time, continuation of the initial triggering event, detection of a new triggering event, etc. In some examples, the container 320 may be configured to initiate a destructive element immediately upon detecting certain parameters that reliably indicate the vehicle is experiencing a catastrophic event such as an IED blast, an aircraft crash, etc. For example, an explosion or violent crash event may be detected based on g force, crumple sensors, heat, etc., all or some of which may be used to make an arming determination (e.g. within ms of detection). A firing event may then be determined based on the same parameters persisting or increasing and/or different parameters being detected. These may include, for example, sustained excessive g force, crumpling proceeded by rapid heat and/or deceleration, etc. In some examples, the arming and firing signals may be generated in a matter of ms (e.g. less than 50 ms or less than 20 ms), and may allow for the destructive element to initiate before secondary damage to the container (such as fire, blast and/or collision) renders the system inoperative or breaches the container, potentially spilling the contents thereof.

In some embodiments, multiple sensor packages may be used to confirm a firing or other event, and different operational modes may be differentiated such that specific sensor packages require confirmation from other pre-designated sensor packages. This may be advantageous for a number of reasons. For example, certain sensor packages may be attached to parts of the vehicle that might be blown off in an explosion (e.g. sensor packages mounted to the periphery of the vehicle). Therefore, sensor packages disposed on the periphery of the vehicle may be associated with one or more sensor packages disposed toward the middle of the vehicle for firing event confirmation. Other configurations are also possible, such as associating all of the peripheral sensor packages with one centrally mounted sensor package, and/or creating dynamic associations in order to tailor the necessary countermeasure response.

As described above, exemplary systems and methods may use multiple sensor packages, each containing multiple accelerometers, proximity detectors or other sensors. It should be further understood that sensing systems and algorithm described herein can be configured to function through individual sensor data drop-outs. For example, exemplary systems may be configured such that data interruption from any one of the available sensor packages will not preclude determining that an event has occurred, based on data received from the remaining sensors. Additionally, exemplary systems may be configured such that data interruption from any one of the sensors within a sensor will not preclude determining that an event has occurred based on data received from the remaining sensors.

In some embodiments, interfaces 324 and/or 322 may also be configured to disarm container 320, e.g. manually disarm by entering passcodes, etc.

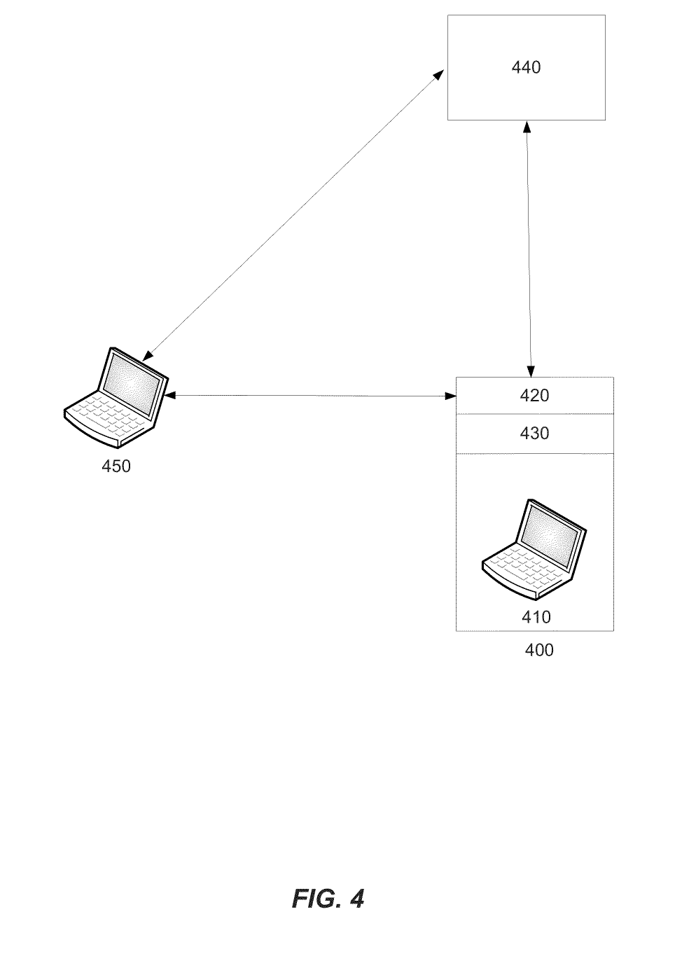

FIG. 4 shows a communication environment with a container 400 communicating via an interface 420 with a computing device 450 and a remote server 440. In some examples, the computing device 450 may use cryptographic or other sensitive material stored on device 410 without storing the information on the device 450. This communication may be made via wired or wireless interface 420 and device 40 may maintain power via a control and power source 430 included in container 400. Container 400 may include various features previously discussed with respect to containers 100 and 320.

In some embodiments, device 450 and/or remote server 440 may be used to set operational modes including various destruction criteria that are applied by container 400. In some instances, destruction of material 410 may be command initiated by device 450 and/or remote server 440.

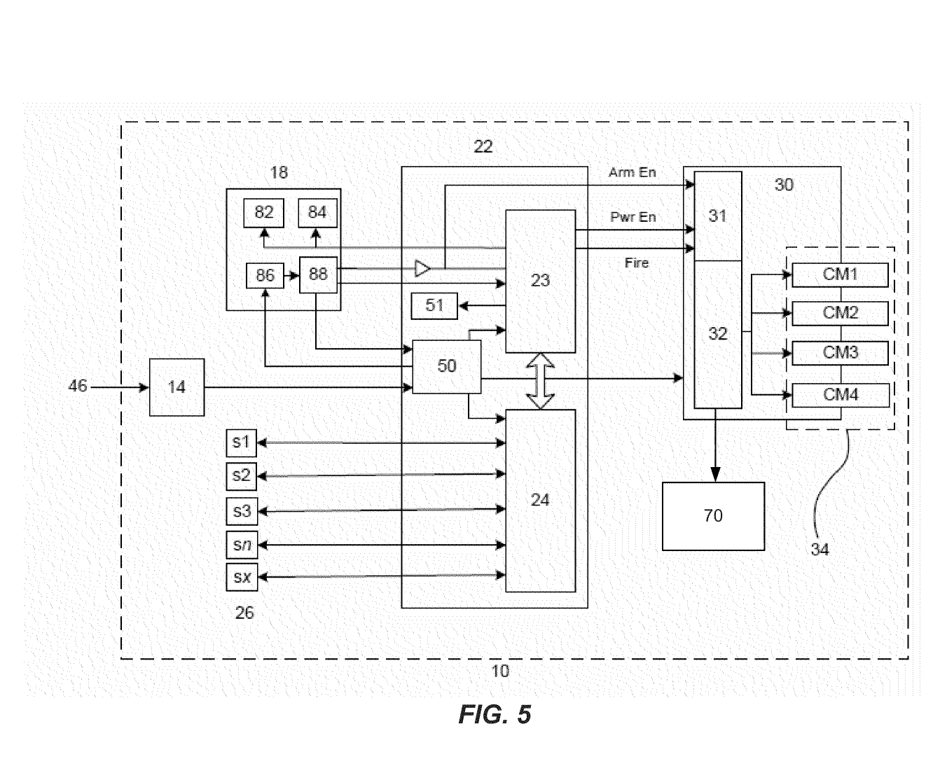

Depicted in FIG. 5 is a simplified schematic of an exemplary trigger and activation system (TAS) 10 that may be applicable with the present invention. TAS 10 may include first responder unit (FRU) 14, control display assembly (CDA) 18, processor 22, one or more sensors 26, electronic safe and arm device (ESAD) 30, and one or more countermeasures 34. Although conceivably useful wherever force-related countermeasures are desirably deployed, as to prevent vehicle rollover, for example, TAS 10 is especially designed for use in connection with a vehicle operating in a theatre in which IEDs, mines, or other explosive devices may be present, along with other anti-vehicle weapons, such as rocket propelled grenades, guided missiles, etc.

A processor 22 (which may be configured in various ways described herein), may include, for example, a microcontroller 23 connected via a bus to interface system (IC) 24, power conditioner 50, data recorder 51, and various other electronic storage, and/or communication means known by those of skill in the art. IC 24 may be connected to a plurality of sensors 26, including acceleration sensor packages, projectile detectors, as well as various other sensor types (sx), which may include, for example, cameras, light sensors, radiation sensors, deformation sensors, heat sensors, pressure sensors, contact sensors, proximity sensors, strain sensors, and force sensors.

In embodiments, the processor 22 may be in communication with other sensor types (sx) that sense a different type of condition than the acceleration sensors, and the processor 22 may be configured to process signals received from the other sensor devices in determining whether to initiate the countermeasure. For example, when the other sensor types (sx), include cameras, light sensors, radiation sensors, deformation sensors, heat sensors, pressure sensors, contact sensors, proximity sensors, strain sensors, and/or force sensors, one or more of a change in light patterns, detected light, radiation, pressure, temperature, contact, proximity, strain and/or force may be used as an independent indicator and/or an additional confirmation threshold that further informs the decision making process on whether an explosion has occurred, and/or whether to activate a countermeasure, e.g. to mitigate the effect of an explosion or to counter an incoming projectile or other threat, as well as to arm and/or initiate a destructive element as described herein.

In some examples, multiple sensor types may be used to more precisely select and time the firing of active countermeasures to defeat or degrade an incoming projectile such as a rocket or missile. In some examples, the ESAD 30 may be configured to send a firing instruction to the same countermeasure to counter an explosion, such as an IED, based on analysis of first sensor data (e.g. accelerometer data), and to counter a projectile, or other threat, based on analysis of second sensor data that includes at least some different sensor types than the first sensor data (e.g. active RF sensor data).

ESAD 30 may include various components including, for example, controller 31 including hardware and/or software for processing signals including Arm, Power and Fire instructions received from the processor 22. ESAD 30 may further include a safety 32 through which firing signals to any of countermeasures 34 must pass. Controller 31 may be configured to power on, or otherwise make ready, safety 32 such that Fire instructions received from the processor 22 are communicated, e.g. by electrical current sufficient to activate an initiator, to appropriate countermeasures 34.

The ESAD 30 may function to arm and initiate countermeasures 34 upon command of processor 22. Like various other aspects of the inventive systems, the ESAD 30 preferably “fails safe”—i.e. if it is non-functional, it enters or reverts to a mode in which countermeasures 34 cannot activate. Primer cord or any other suitable material may connect the ESAD 30 to the countermeasures 34. In embodiments, the ESAD 30, or other safe and arming device, may be collocated with the countermeasure, e.g. in a countermeasure cartridge.

With TAS 10 in the “arm enable” mode, processor 22 controls deployment of countermeasures 34. Processor 22 directly or indirectly receives signals from sensors 26 (e.g. via IC 24 and any busses) and determines (1) if making ready ESAD 30 is appropriate, and (2) if deployment of any countermeasure 34 is appropriate. If making ready and/or deployment is appropriate, as described further herein, processor 22 signals ESAD 30 accordingly. In some versions of the invention, processor 22 may be housed in an enclosure having deformable brackets so as to allow dampening of shocks otherwise likely experienced by the processor 22.

FRU 14 may include, for example, a switch interposed in the main power supply line 46 of the vehicle between a vehicle power supply (e.g. a battery or electrical generator) and ESAD 30 to which countermeasures 34 are connected. If the switch in FRU 14 is open, electricity is not available for ESAD 30 to arm the countermeasures 34 for deployment.

In embodiments, various parts of the TAS may be connected to and/or include an auxiliary power source, in addition to the main power supply line 46 of the vehicle. For example, power conditioner 50 may be connected to and/or include an auxiliary power source sufficient to power essential parts of the TAS 10 and/or container 70 for a period of time sufficient to deploy countermeasures and arm/initiate container 70, if the vehicle experiences an IED blast that disrupts power from main power supply line 46. As described above, container 70 may also include its own power source sufficient to arm and/or initiate a destructive element even if the container is completely disconnected from the main power supply 46 and the ESAD auxiliary power source. The auxiliary power source may be, for example, a capacitor (e.g. a 27,000 uF super capacitor) that allows the system to function for at least 100 ms after battery power is lost. This can assure a functioning system even if the battery power is lost from the IED blast.

As noted in FIG. 12, CDA 18 beneficially may, but need not necessarily, include a system status indicator 82, a safety status indicator 84, a power indicator 86, and an armed power control indicator 88. CDA 18 additionally advantageously may be powered by power supply 46 (albeit perhaps after the power undergoes conditioning by power conditioner 50), although other sources of electricity possibly may be used instead. Outputs of CDA 18 may be connected electrically to (at least) processor 22.

Once a decision to activate a countermeasure is made, a FIRE command signal may be sent to one or more countermeasures 34 depending on, for example, the sensor packages meeting the selected acceleration and/or projectile detection criteria, and quadrant correspondence of sensor packages and/or countermeasures. Likewise, an arming and/or firing signal may be sent by ESAD 30 to container 70, which may include communication links and other features described with respect to containers 100, 320 and 400. In some examples and/or modes, the ESAD 30 and/or container controller may determine that destruction of the container contents is appropriate based on sensor data alone, e.g. catastrophic destruction of the vehicle, whereas in other instances/modes, the container may start a timing sequence, activate an alarm, and allow time for a surviving user to disarm the container. This may be important, for example, in allowing surviving users to maintain secure communication using cryptographic devices contained in the container 70.

Depending on the locations and types of forces or threat indicators encountered by sensors 26, any one or more countermeasure panels, rows of countermeasures, individual countermeasures, or container destruction elements may be initiated.

In some examples, upon receipt of a suitable signal from processor 22, ESAD 30 may activate a signal or explosive train, that causes activation of destructive element such as 130 shown in FIG. 1. Detonation of an explosive cord can cause deflagration (if pyrotechnic) or other activation of charges and/or incendiary so as to cause content destruction. A single initiator may be employed to activate, release, detonate and/or ignite any number of countermeasures and/or destructive elements. Alternatively, each countermeasure and/or destructive element may be associated with a separate initiator. To expedite initiation, capacitors associated with one or more initiators may be pre-charged under certain conditions, such as when the ESAD is made ready.

In some embodiments, a computer-readable medium containing computer-readable instructions recorded thereon is provided. For example, one or more memory devices (included in, or in communication with, processor 120 shown in FIG. 1) may store an application or computer program product accessible from a computer-usable or computer-readable medium providing program code for use by or in connection with processor 120 or any instruction execution system. For the purposes of this description, a computer-usable or computer-readable medium may include any tangible medium or apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device), or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks may include compact disc read-only memory (CD-ROM), a rewritable compact disc (CD-R/W), and digital video disc (DVD).

A data processing system (e.g., processor 120 shown in FIG. 1) is suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) may be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

Any wireless protocol using any wireless communication standard may be supported by the systems and methods described herein. In addition, any computing device may be adapted to support the techniques disclosed herein. Furthermore, it is to be understood that the various embodiments described above may be used and adapted for other countermeasure controls not specifically described herein.

It is to be understood that the examples and embodiments described above are for illustrative purposes only and that various modifications or changes in light thereof will be suggested to persons skilled in the art, and are to be included within the spirit and purview of this application and scope of the appended claims. Therefore, the above description of specific exemplary embodiments should not be understood as limiting the scope of the invention as defined by the claims.

What is claimed is:

1. A container, comprising:
a storage space;
a content destruction element configured to destroy material contained in the storage space;
an arming device configured to arm the content destruction element, and to initiate the content destruction element based on at least one firing criteria.

2. The container of claim 1, wherein the content destruction element includes at least one of an incendiary, an explosive, a liquid, a gas, a magnet or an electrical source.

3. The container of claim 1, wherein the at least one firing criteria includes at least two of movement of the container, acceleration, penetration of the container, elapsed time, and a firing signal.

4. The container of claim 3, further comprising at least one of a positioning system configured to determine a position and movement of the container, or an accelerometer configured to detect an acceleration of the container.

5. The container of claim 1, wherein the arming device is further configured to disarm the content destruction element based on at least one of a disarm signal or a container opening.

6. The container of claim 1, further comprising an enclosure configured to at least one of mitigate an effect of the content destruction element outside of the container, or to direct an effect of the content destruction element in a particular direction.

7. The container of claim 1, further comprising a communication link configured to allow communication with an electronic device in the storage space, and a power link configured to provide power to the electronic device in the storage space.

8. The container of claim 1, wherein the arming device is configured to arm the content destruction element based at least in part on a signal received from outside of the container.

9. The container of claim 1, further comprising an alarm configured to activate based at least in part on the content destruction element being armed.

10. The container of claim 1, wherein the container is at least one of a GSA class 5 safe, or a GSA class 6 safe.

11. A material destruction system comprising:
a container;
a content destruction element configured to destroy material in the container;
an arming device configured to arm the content destruction element based on at least one arming criteria, and to initiate the content destruction element based on at least one firing criteria,
wherein the at least one arming criteria includes at least one of movement of the container, acceleration, penetration of the container, and an arming signal, and
wherein the at least one firing criteria includes at least one of movement of the container, acceleration, penetration of the container, elapsed time, and a firing signal.

12. The system of claim 11, wherein the at least one firing criteria includes at least two of movement of the container, acceleration, penetration of the container, elapsed time, and the firing signal.

13. The system of claim 11, wherein the container is included in a vehicle, and at least one of:
the at least one arming criteria includes an arming signal provided by an active countermeasure system onboard the vehicle, or
the at least one firing criteria includes a firing signal provided by the active countermeasure system onboard the vehicle.

14. The system of claim 11, further comprising:
a first sensor;
a second sensor; and
a processor in communication with said first sensor, said second sensor and said arming device,
wherein said processor is configured to at least one of arm or initiate said content destruction element based on results of processing signals from said first sensor, and based on results of processing signals from said second sensor.

15. The system of claim 11, wherein said content destruction element includes at least one of an incendiary or an explosive.

16. The system of claim 11, further comprising an alarm configured to activate based at least in part on the content destruction element being armed, and a controller in communication with said arming device, wherein said arming device is configured to disarm said content destruction element based at least in part on input received from said controller.

17. The system of claim 16, wherein said controller is at least one of a control panel on an outside of the container, a control panel on a vehicle, or a remote control.

18. A method of destroying material in a container, said method comprising:
arming a content destruction element based on an arming criteria including at least one of movement of the container, acceleration, penetration of the container, and an arming signal;
activating an alarm based at least in part on said arming the content destruction element;
monitoring, by at least one microprocessor, a firing criteria including at least two of movement of the container, acceleration, penetration of the container, elapsed time, and a firing signal; and
at least one of:
initiating the content destruction element based on the occurrence of the firing criteria, or
making the content destruction element safe based on a disarm signal,
wherein occurrence of at least one of the arming criteria and firing criteria are determined based on data provided by a sensor of the container.

19. The method of claim 18, wherein the content destruction element includes at least one of an incendiary, an explosive, a liquid, a gas, a magnet or an electrical source.

20. The method of claim 18, wherein the material includes data stored on an electronic device, and the content destruction element includes at least one of an incendiary, an explosive, a magnet or an electrical source.

21. The method of claim 18, wherein the material includes at least one of printed text or images, and the content destruction element includes at least one of an incendiary, a liquid or a gas.
